(19) United States
(12) Patent Application Publication
(10) Pub. No.: US 2009/0308260 A1
(43) Pub. Date: Dec. 17, 2009

(54) Grilling appliances and a method for grilling food products

(76) Inventor: Yechiel Trost, Hadera (IL)

Correspondence Address: HENRY M. SINAI;(IP-PARTNERSHIP), P.O. BOX 669, RAANANA, 43350, IL

(21) Appl. No.: 12/449,216

(22) PCT Filed: Jan. 27, 2008
(86) PCT No.: PCT/IL2008/000115

§ 371 Date: Jul. 29, 2009

Related U.S. Application Data
(60) Provisional application No. 60/898,401, filed on Jan. 31, 2007.
(60) Provisional application No. 60/935,166, filed on Jul. 30, 2007.

(51) Int. Cl. A47J 37/06

(52) U.S. Cl. 99/349; 99/372; 426/523

(57) ABSTRACT

A cooking and grilling appliance and a method for cooking and grilling food products including whole chickens are provided. The cooking appliance includes a base unit supporting a lower cooking plate; a top unit containing an upper cooking plate and a pair of side levers pivotally connecting the upper cooking plate to the lower cooking plate. The angle of the upper cooking plate is variable relative to the lower cooking plate. The cooking appliance further includes an operating and locking mechanism in communication with the side levers and a pressure bar connected to the side levers. When the upper cooking plate is lowered, the locking mechanism locks the upper and lower plates together and on lifting the handle and pressure bar, the operating mechanism releases the locking mechanism, thereby allowing the upper cooking plate to be raised from the lower cooking plate.

### FIELD OF THE INVENTION

The present invention relates to cooking devices for grilling and particularly to a grilling appliance for cooking whole chickens, meat products and other food products.

### BACKGROUND OF THE INVENTION

There are numerous types of electrical grilling appliances known in the prior art including grilling appliances, which are known as contact grills, having a pair of grill plates for holding the food article to be grilled. However, such grilling appliances usually require a considerable period of time to grill a steak or hamburger. Other appliances are known, such as described in U.S. Pat. Nos. 4,762,058 and 5,181,455, which permit food articles to be grilled in a relatively short period of time.

Most contact grill appliances are configured to accept a relatively thin slab of meat, such as a hamburger, sausage or steak and are unsuitable for cooking thicker items such as pieces of chicken. Prior art grilling appliances are not designed to grill a whole chicken, for example.

An object of the present invention is to provide an electrical grilling appliance which permits whole chickens, meat products and other thicker food products to be grilled in a very short period of time.

### SUMMARY OF THE PRESENT INVENTION

The present invention provides a cooking appliance for cooking and grilling foodstuffs including chicken and meat products and in particular is configured to for grilling whole chickens.

There is thus provided a cooking appliance in accordance with an embodiment of the present invention. The cooking appliance includes a base unit supporting a lower cooking plate; a top unit containing an upper cooking plate and a pair of side levers pivotally connecting the upper cooking plate to the lower cooking plate. The angle of the upper cooking plate is variable relative to the lower cooking plate.

Furthermore, in accordance with an embodiment of the present invention, the cooking appliance further includes a handle connected to said pair of side levers and a pressure bar connected to the side levers, the pressure bar being proximate the handle. By action of the handle and a pressure bar together, the upper plate is movable between an open position for placing the food article to be cooked and a closed lockable position for compressing and sealing the food article between the upper plate and lower plate for cooking the food article and for locking the upper plate and lower plate during cooking.

Furthermore, in accordance with an embodiment of the present invention, the cooking appliance further includes a pair of generally “L”-shaped bars, each of which are attached to each of the pair of side levers; a pair of toothed pinions attached to the base unit; a pressure application mechanism located inside one of the pair of side levers and a first gear wheel located in the second of the pair of side levers.

Furthermore, in accordance with an embodiment of the present invention, the pressure application mechanism includes a second gear wheel for engaging the toothed pinion, the first and second gear wheels being connected via a common shaft located within the base unit, a ratchet allowing the second gear wheel to be rotated in one direction only thereby lowering the side lever along the pinion and a sliding lever having an indentation formed at one end thereof, the indentation interconnecting with the teeth of the second gear wheel thereby to rotate the second gear wheel.

Furthermore, in accordance with an embodiment of the present invention, the pressure application mechanism further includes a slider in communication with a spring and a cable connecting the slider to a cam located within the handle; wherein pressure of the spring causes the toothed pinion to be pressed into contact with the second gear wheel.

In addition, in accordance with another embodiment of the present invention, the cooking appliance further includes an operating mechanism in communication with the pair of side levers and a locking mechanism integrated with the operating mechanism. When the upper cooking plate is lowered, the locking mechanism locks the upper and lower plates together and on lifting the pressure bar, the operating mechanism releases the locking mechanism, thereby allowing the upper cooking plate to be released and raised from the lower cooking plate.

Furthermore, in accordance with an embodiment of the present invention, the operating mechanism includes a main arm assembly. The main arm assembly includes a plurality of rod equidistantly spaced around the circumference of an aperture extending through the main arm assembly and a secondary arm assembly configured to receive the plurality of rod extending from the main arm assembly.

Furthermore, in accordance with an embodiment of the present invention, the locking mechanism includes a locking cam assembly and a locking ring having an aperture formed therein, the aperture configured to fit onto the external diameter of the cam unit. The locking cam assembly includes a cam unit having a plurality of cam components formed around a central body; the central body includes a cylindrical element attached to one side of the central body and a disc attached to the other side of the central body.

Furthermore, in accordance with an embodiment of the present invention, the locking cam assembly further comprises a plurality of springs, each spring fitted within an aperture formed within each of the plurality of cam components and a plurality of rods insertable within the cam unit adjacent to and perpendicular to each of the plurality of springs.

Furthermore, in accordance with an embodiment of the present invention, the lower cooking plate is configured to hold the sliced whole chicken, and comprises a recess for holding a whole chicken which has been opened out after being cut from the breast side. Alternatively, the upper cooking plate is configured to hold the sliced whole chicken, and comprises a recess for holding a whole chicken which has been opened out after being cut from the breast side.

Finally, in accordance with an embodiment of the present invention, there is provided a method for grilling and cooking whole chickens. The method includes the steps of:

cutting the chicken open from the breast side; and

placing the cut chicken in a recessed plate, the recess being configured to accept the curvature of the cut chicken.

The recessed plate is either one of the upper or lower cooking plates of a cooking appliances.

### BRIEF DESCRIPTION OF THE DRAWINGS

The present invention will be understood and appreciated more fully from the following detailed description taken in conjunction with the appended drawings in which:

FIG. 1 is an isometric view of the grilling appliance, according to an embodiment of the present invention;

FIG. 2 is a sectional elevation of the side lever of the grilling appliance of FIG. 1 illustrating the pressure application mechanism;

FIG. 3 is an enlarged detail of the mechanism of FIG. 2;

FIG. 4A illustrates a plate configured to hold a whole chicken for use with the appliance of FIG. 1;

FIG. 4B is a cross-section along A-A of the plate of FIG. 4A;

FIG. 4C is a cross-section along B-B of the plate of FIG. 4A;

FIG. 5 is a photograph a cut chicken prepared for cooking with the plate of FIG. 4A;

FIG. 6 is a side elevational view of an alternative embodiment of a side lever for the grilling appliance of FIG. 1 illustrating the pressure application mechanism;

FIG. 7 is an exploded view of the components of the side lever of FIG. 6;

FIG. 8 is detailed isometric view of the locking ring of FIG. 6; and

FIGS. 9A and 9B are elevational views of the locking mechanism of FIG. 6.

### DESCRIPTION OF THE PRESENT INVENTION

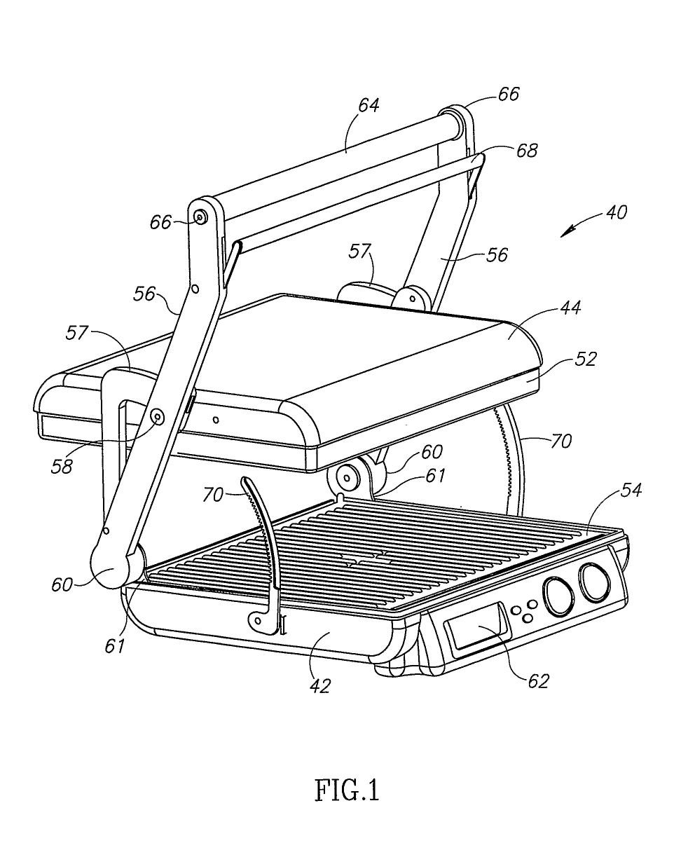

The present invention relates to a cooking device for grilling chicken, meat and other food products and is particular suitable for grilling whole chickens. Reference is now made to FIG. 1 which is an isometric view of a grilling appliance, generally designated 40, constructed in accordance with an embodiment of the present invention.

The appliance 40 comprises a base unit 42 and a top unit 44. The top unit 44 includes an upper cooking plate 52 and base unit 42 supports a lower cooking plate 54. The upper cooking plate 52 and lower cooking plate 54 are pivotally connected to each other by a pair of side levers 56. The upper cooking plate 52 is pivotally attached at pivot point 58 to the side levers 56. The appliance 40 is shown in its open position ready to receive a product for cooking.

The lower cooking plate 54 is pivotally attached (pivot point 60) to the distal end 61 of base unit 42 by the pair of side levers 56. The lower cooking plate 54 may be supported at its proximal end (in the front of the base unit 42) by a spring (not shown) or other similar cushioning device to allow the lower plate 54 to be tilted at an angle to the horizontal plane when pressure is applied, and thus facilitating the dropping of melted fat and other liquids into a trash collector 62.

The springy support ensures that the pressure remains constant during cooking as the thickness of the food article becomes slightly reduced. When the pressure is released, the lower plate 54 returns to its initial horizontal position. This prevents the food from sliding out.

A handle 64 is attached to the other end 66 of the pair of side levers 56. A pressure bar 68 is also attached to the pair of side levers 56, proximate end 66. The handle 64 is used to move the top unit 44 holding the upper plate 52 and together with the bar 68 to apply pressure in order to secure the upper plate 52 to the lower plate 54. Each of a pair of generally “L”-shaped bars 57 are attached to each of the pair of side levers 56 at pivot points 58 and 60.

When pressure is applied to the food article by the action of the levers 56 and pressure bar 68 pushing the upper cooking plate 52 onto the food article, the angle of the upper plate 52 (relative to the lower plate 54) may vary.

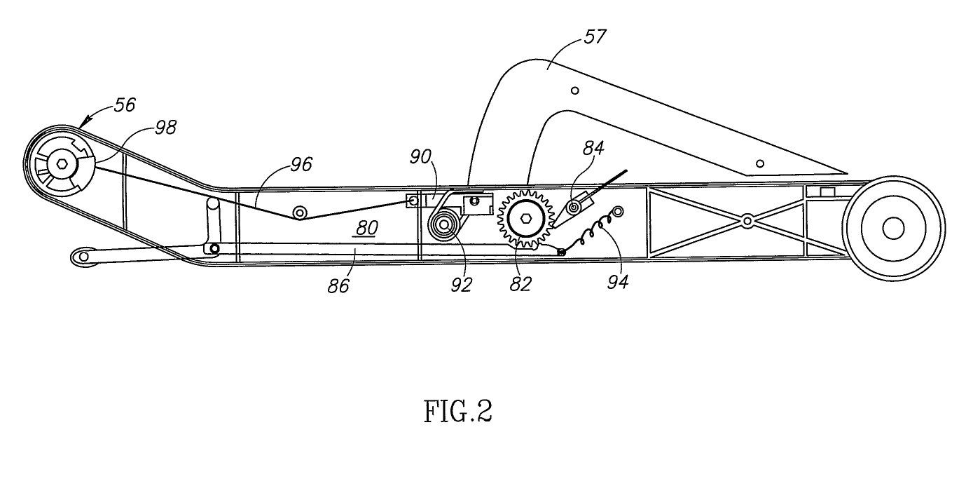

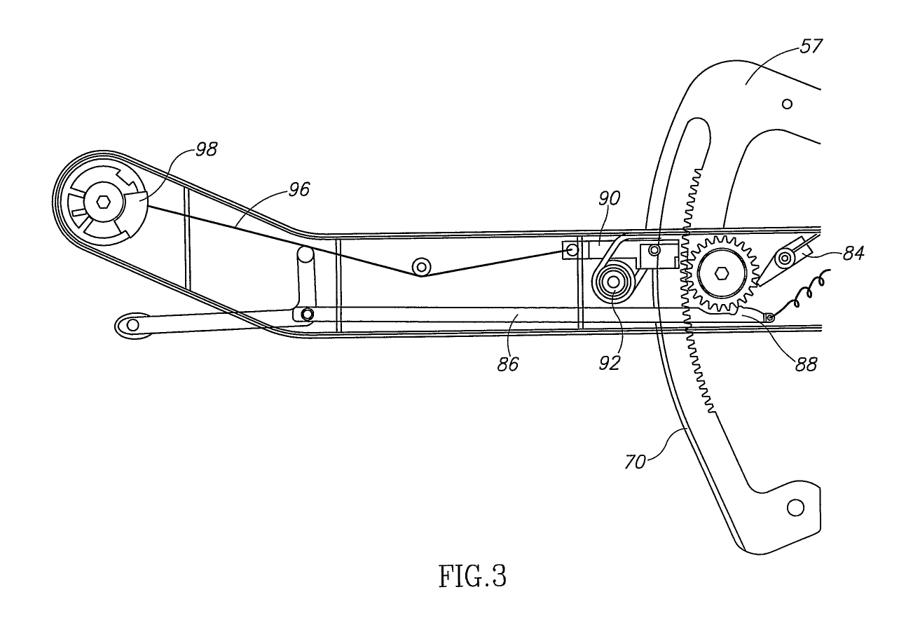

The appliance 40 further comprises a pair of toothed pinions 70 attached to the base unit 42 and a pressure application mechanism 80 (best seen in FIGS. 2 and 3, described hereinbelow) located inside one of the side levers 56.

Reference is now made to FIGS. 2 and 3. FIG. 2 is a sectional elevation of the side lever 56 illustrating the pressure application mechanism, generally designated 80. FIG. 3 is an enlarged detail of the mechanism 80 also illustrating the engagement of the toothed pinion 70.

The mechanism 80 comprises a gear wheel 82 for engaging the toothed pinion 70, a ratchet 84 and a sliding lever 86. A second gear wheel (not shown) is located in the second side lever, the two gear wheels being connected with a common shaft (not shown) located within the top unit 44.

The ratchet 84 permits the rotation of the gear wheel 82 in one direction only lowering the side lever 56 along pinion 70. The gear wheel 82 is rotated by the movement of having an indentation 88 (tooth) formed at one end of the sliding lever 86 interconnecting with the teeth of the gear wheel 82.

The mechanism 80 further comprises a slider 90 in communication with a spring 92. A cable 96 connects the slider 90 with a cam 98, attached internally to the handle 64.

The pressure of a spring 92 connected to the slider 90 causes the toothed pinion 70 to be pressed into contact with the gear wheel 82.

The sliding lever 86 is moved in the active direction by pressing the bar 68 toward the handle 64. A second spring 94 is provided, which is connected at one end to the sliding lever 86 and at its other end to lever 56. The second spring 94 allows the lever 86 and the bar 68 to be returned to their original position. By rotating the handle 64, the cable 96 causes the slider 86 to be released thereby detaching the toothed pinion 70 from the gear wheel 82 permitting the free movement of the handle 64 and the upper plate 52.

Since the pivot point 58 of the side levers 56 passes through or over the center of gravity of the upper plate 52, pressure is effectively applied at the central axis of the plates. Thus, the angle of the upper plate 52 is variable and may be adjusted relative to the lower plate 54. Thus, the cooking device 40 can accommodate different shapes and sizes of food products.

It will be appreciated that the cooking method described hereinabove is not limited to the application of pressure from mechanical means, but that pressure may be applied by any other suitable means known in the art, which applies pressure between the two heated plates holding the food being cooked. Cooking under pressure speeds the cooking process significantly. In the case of a whole chicken, for example, the typical cooking time is approximately 12-15 minutes compared with over one hour by traditional oven cooking methods.

Both upper and lower plates are removable and easy exchangeable. Electric heaters with reflectors may be located below the lower plate and above the upper plate. The heat may be transmitted to the external side of the plates by infrared radiation. A temperature switch is suitable connected to each plate. This switch may be configured to interrupt the electric current to the heater when the desired temperature of the plate is reached.

Special Plate for a Whole Chicken.

Generally, grilling appliances are utilized for cooking burgers, sausages, steak and chicken pieces but are incapable of cooking a whole chicken. The inventors have realized that a whole chicken may be grilled on a cooking device by use of a plate, especially configured to hold a whole chicken.

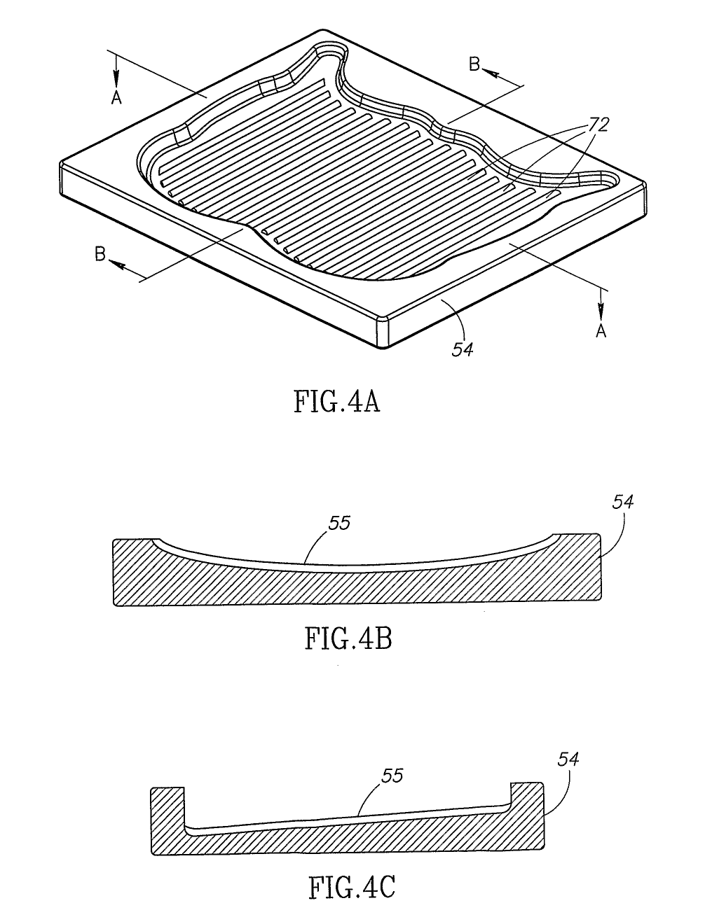

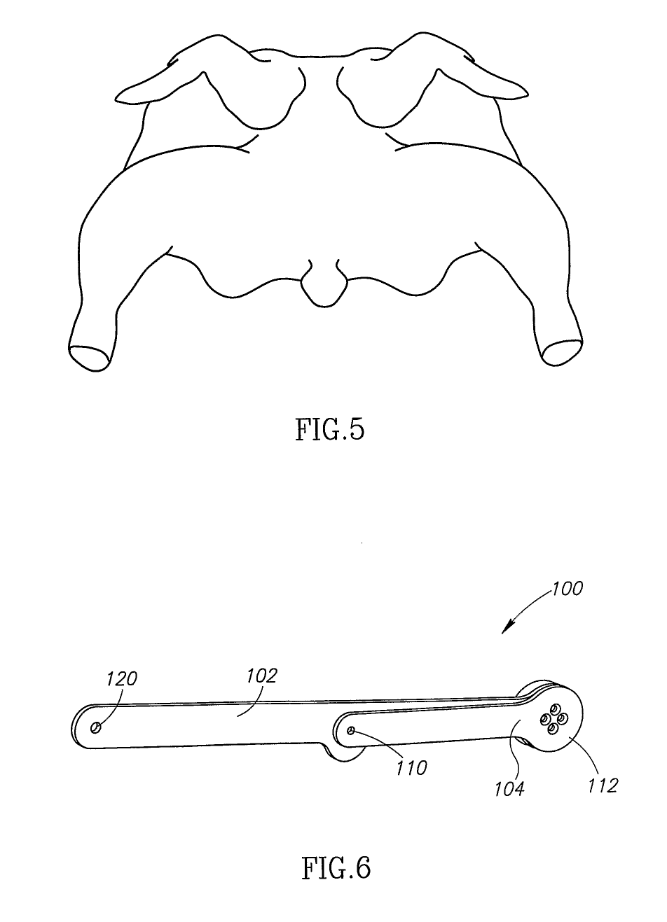

Reference is now made to FIGS. 4A-4C and 5. A schematic and isometric view of a plate 54, configured to the shape and curvature of a sliced whole chicken (FIG. 5), is shown in FIG. 4A. FIGS. 4B and 4C are cross-sectional elevations along A-A and B-B, respectively of the plate 54. Plate 54 comprises a recess 55 to hold the sliced whole chicken, which has been opened out after being cut from the breast side (see FIG. 5). Alternatively, the upper plate 52 may be configured to hold a whole chicken. Preferably, the plate 54 is configured to the cut shape of the chicken so that the plate, when viewed in cross-section B-B in FIG. 4C, is deeper at one end than the other. Thus, the open side of the whole chicken when placed in the plate after being cut as shown, appears flat and will close against the flat face of the second plate (upper or lower depending on which plate is chosen to hold the chicken).

The shape preferably matches the shape of the chicken, thereby enabling a consistent and equal contact between the plates and the chicken. In this way, all parts of the chicken may be evenly roasted.

On the lower plate, indications 72 may be marked to illustrate the recommended position of the flattened chicken after it is cut from the breast side. Alternatively, the chicken plate may replace the lower plate. In this case, the cooking will take place without the liquid being drained and the chicken will sit in the heated liquid.

Method of Preparing a Whole Chicken

The preferred method of preparing a whole chicken includes cutting the chicken so that it may be placed on the lower or the upper plate. One of the plates (FIG. 4A), preferably the upper plate, is configured to the shape and curvature of a sliced whole chicken, as shown. The shape preferably matches the shape of the chicken, thereby enabling a consistent and equal contact between the plates and the chicken. In this way, all parts of the chicken may be evenly roasted.

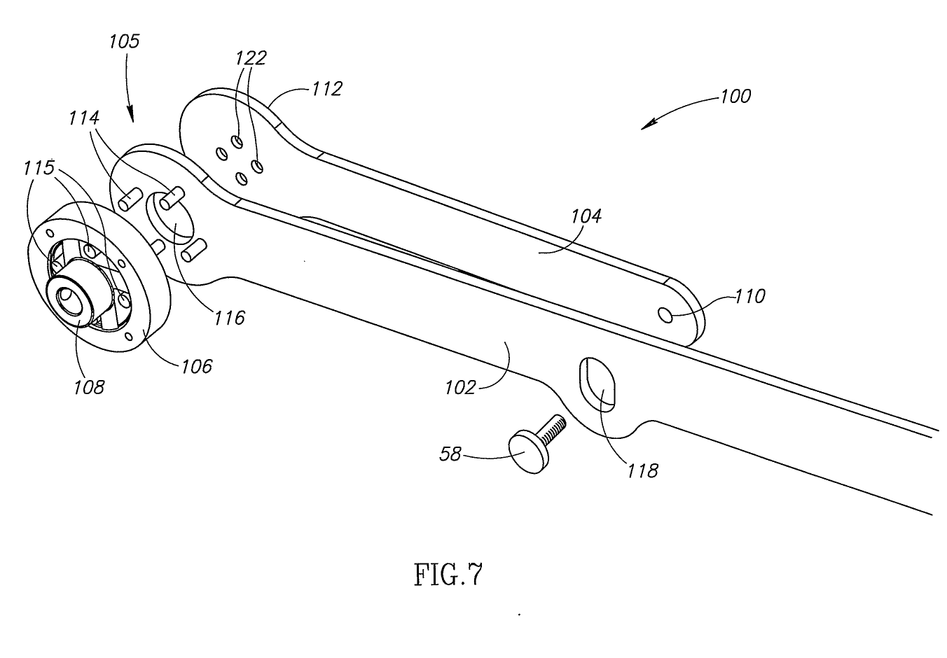

Reference is now made to FIGS. 6-9. FIG. 6 is a side elevational view of an alternative embodiment of side levers, generally designated 100, attaching to the grilling appliance of FIG. 1. FIG. 7 is an exploded view of the components of the side lever 100, which comprises a main arm assembly 102, a secondary arm assembly 104, and a locking mechanism, generally designated 112 comprising a locking ring 106 and a locking cam assembly 108.

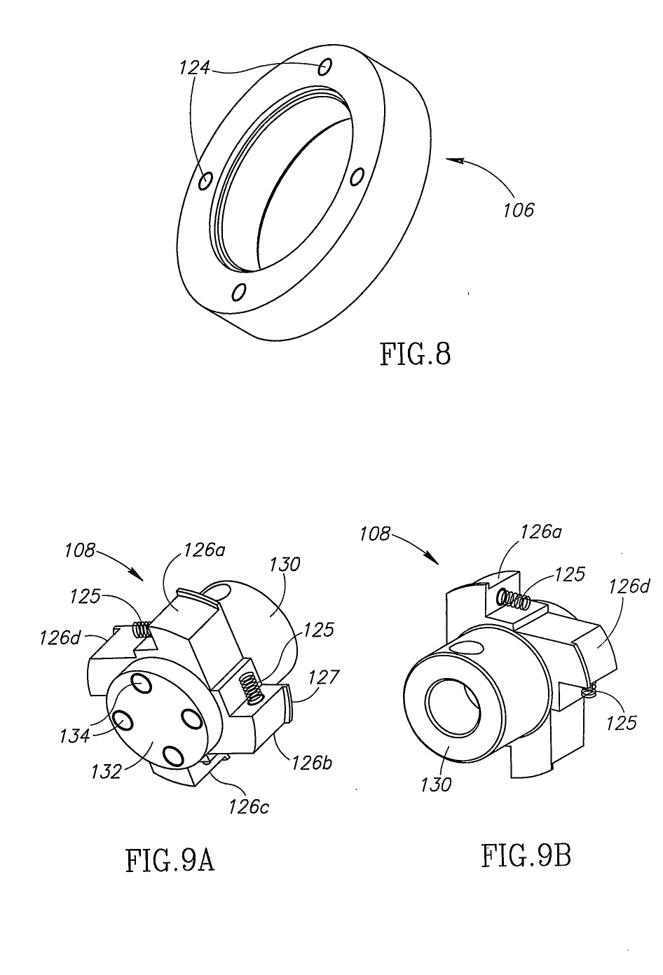

FIG. 8 is detailed isometric view of the locking ring 106 and FIGS. 9A and 9B are isometric views of the locking cam assembly 108.

In the embodiment of FIGS. 6-9, the upper plate 52 and lower plate 54 of the appliance 50, are pivotally connected to each other by a pair of side levers 100. Side levers 100, which replace side levers 56 illustrated in the embodiment of FIGS. 1-3, comprise an operating mechanism, generally designated 105, which replaces the pressure application mechanism 80. The use of operating mechanism 105 also replaces the toothed pinions 70 of the embodiment of FIGS. 1-3 and the pair of “L”-shaped bars 57 attached to the pair of side levers 56.

The upper cooking plate 52 is pivotally attached at pivot point 110 (equivalent to pivot point 58 of side levers 56) of the side levers 100. The lower base unit 42 is pivotally attached at its distal end 61 to the locking mechanism end 112 of the pair of side levers 100. End 112 comprises the locking mechanism of the side levers 100. The handle 64 (shown in FIG. 1) connects the pair of side levers 100. Similarly, the pressure bar 68 (shown in FIG. 1) is attached to the pair of side levers 56, proximate end 66. The handle 64 is used to move the top unit 44 holding the upper plate 52 and together with the pressure bar 68 to apply pressure in order to secure the upper plate 52 to the lower plate 54. Lifting the handle 64 and pressure bar 68 releases the locking mechanism, as will be described hereinbelow.

Operating mechanism 105 comprises a main arm assembly 102, a secondary arm assembly 104, in communication with main arm assembly 102, a locking mechanism comprising a locking ring 106, a locking cam assembly 108 and a plurality of rods 115 (FIG. 7), which are suitable interconnected at the locking end 112 of the side levers 100, as will now be described.

Main arm assembly 102 comprises a plurality of rods 114 equidistantly spaced around the circumference of an aperture 116 at locking end 112. Rods 114 are configured to extend through main arm assembly 102 (best seen in FIG. 6). Main arm assembly 102 further comprises a second substantially oval aperture 118 positioned at pivot point 110 and a third aperture 120 located at the distal end from locking end 112. The oval aperture 118 is configured to accept locking pin 58 (which secures the secondary arm assembly 104 to the top unit 44) while allowing the main arm assembly 102 to move freely within the aperture 118.

Secondary arm assembly 104 comprises a plurality of receivers 122 located at locking end 112 and an opening formed at pivot point 110 (to receive the locking pin 58) at distal end from locking end 112. The plurality of receivers 122 are configured to receive rods 114 extending from main arm assembly 102.

Locking ring 106 (FIG. 8) comprises a plurality of apertures 124 formed within the annulus equidistantly spaced around its circumference, to receive screws for fixing to the appliance.

Locking cam assembly 108 (FIGS. 9A and 9B) comprises a four-section cam 126a-126d formed around a central body 128 having a cylindrical element 130 attached to one side of the central body 128 and having a disc 132 attached to the other side of the central body 128. Each component of the four-section cam 126a-126d has an aperture formed therein to receive a spring 125. Additionally, Each component of the four-section cam 126a-126d comprises a lip 127 protruding from the cams 126a-126d.

Disc 132 has a plurality of receiving orifices 134 equidistantly spaced around the circumference of the disc 132. The internal diameter of locking ring 106 is configured to match the external diameter of the four-section cam 126 that is the diameter exemplified by the lips 127.

The components comprising the side levers 100 are fitted together as follows:
The locking ring 106 is fitted onto the external diameter of the four-section cam 126a-126d;
The locking cam assembly 108 is inserted into the ring 106. The plurality of rods 115 are inserted adjacent to and perpendicular to each of the springs 125. The length of the pins 115 is equivalent to the depth of the ring 106. The pressure exerted by the springs 125 on the rods 115 prevents the cam 108 from rotating against the compressed springs.
The extended plurality of rods 114 is insertable into the plurality of receiving orifices 134 of disc 132. When inserted, the rods 114 are located between each of the cams 126a-126d, adjacent each of the rods 115.
The receivers 122 of secondary arm assembly 104 are attached to the extended plurality of rods 114 of main arm assembly 102;

The side levers 100 are suitably attached to the lower cooking plate 54 via cylindrical element 130 and suitably attached to upper cooking plate at pivot point 110.

In operation, when the upper cooking plate 52 is lowered and the cooking device is in its closed position, the operating mechanism 105 locks the upper and lower plates, 52 and 54 respectively, together. When the side levers 100 are lowered, the rods 114 are inserted between each of the cams 126a-126d, adjacent each of the rods 115m, effectively locking the cam 126 and preventing any movement.

On lifting the handle 64 and pressure bar 68, the main arm assembly 102 pivots about end 112 within the limitation of oval aperture 118 and rotates the rods 114 releasing them from the locking cam assembly 108 permitting the cam 126 to rotate in one direction only and allowing the upper cooking plate 52 to be raised.

Additional features and advantages of the present invention may be summarized as follows:

1. Mechanical pressure applied by a hot plate to the surface of a food product significantly improves the heat transfer on the surface and in the volume of the food article. The result is a much faster process and the time of roasting is reduced significantly.

2. The pressure may be achieved by the action of the handle.

3. The inclined position of the lower plate in closed position facilitates the removal of melted fat and other juices.

4. The lower plate may be installed in such a way that it follows the position of the upper plate when it is lowered. This enables the evacuation of liquids and bigger contact area between the plates and the food article.

5. Both sides of the plates may be used for grilling. In an embodiment of the invention, one of the faces may be for substantially flat articles such as steak or hamburger, while the other face may have a recess for location of a whole flattened chicken. This plate may be manually turned over. The plates may also be interchangeable. Special plates may be configured for cooking chicken.

6. The mechanical pressure may be applied manually or with an electric motor through a mechanical arrangement thereby increasing the force applied. The arrangement permits the amount of applied force to be selected.

7. The removable plates maybe dishwasher proof for ease of cleaning.

8. Disposable baking paper (or any other suitable material) may be designed to match the shape of the lower and upper plates and fixed in place to facilitate the cleaning of the plates. The shape of a sliced chicken may also be marked on the disposable paper (or any other suitable material) to match the curved plate to the chicken (see FIGS. 4A, 4B and 5.)

It will also be appreciated that the present invention is not limited by what has been described hereinabove and that numerous modifications, all of which fall within the scope of the present invention, exist.

Rather the scope of the invention is defined by the claims, which follow:

1. A cooking appliance, comprising:
a base unit supporting a lower cooking plate;
a top unit containing an upper cooking plate; and
a pair of side levers pivotally connecting the upper cooking plate to the lower cooking plate,
wherein the angle of the upper cooking plate is variable relative to the lower cooking plate.

2. The cooking appliance, according to claim 1, further comprising:
a handle connected to said pair of side levers; and
a pressure bar, connected to said pair of side levers, said pressure bar being proximate said handle,
wherein by action of the handle and a pressure bar together, the upper plate is movable between an open position for placing the food article to be cooked and a closed lockable position for compressing and sealing the food article between the upper plate and lower plate for cooking the food article and for locking the upper plate and lower plate during cooking.

3. The cooking appliance, according to claim 2, further comprising:
a pair of generally “L”-shaped bars, each of which are attached to each of the pair of side levers;
a pair of toothed pinions attached to the base unit;
a pressure application mechanism located inside one of said pair of side levers; and
a first gear wheel located in the second of said pair of side levers.

4. The cooking appliance, according to claim 3, wherein said pressure application mechanism comprises:
a second gear wheel for engaging the toothed pinion, said first and second gear wheels being connected via a common shaft located within the base unit;
a ratchet allowing the second gear wheel to be rotated in one direction only thereby lowering the side lever along the pinion; and
a sliding lever having an indentation formed at one end thereof, said indentation interconnecting with the teeth of the second gear wheel thereby to rotate said second gear wheel.

5. The cooking appliance, according to claim 4, wherein said pressure application mechanism further comprises:
a slider in communication with a spring; and
a cable connecting the slider to a cam located within the handle;
wherein pressure of the spring causes the toothed pinion to be pressed into contact with the second gear wheel.

6. The cooking appliance, according to claim 2, further comprising:
an operating mechanism in communication with the pair of side levers; and
a locking mechanism integrated with said operating mechanism,
wherein, when the upper cooking plate is lowered, the locking mechanism locks the upper and lower plates together; and
wherein, on lifting the handle, the operating mechanism releases the locking mechanism, thereby allowing the upper cooking plate to be raised from the lower cooking plate.

7. The cooking appliance, according to claim 6, wherein said operating mechanism comprises:
a main arm assembly comprising:
a plurality of rods equidistantly spaced around the circumference of an aperture extending through the main arm assembly; and
a secondary arm assembly configured to receive said plurality of rods extending from the main arm assembly.

8. The cooking appliance, according to claim 6, wherein said locking mechanism comprises:
a locking cam assembly comprising:
a unit having a plurality of cam components formed around
a central body, said central body comprising:
a cylindrical element attached to one side of the central body; and
a disc attached to the other side of the central body; and
a locking ring having an aperture formed therein, said aperture configured to fit onto the external diameter of the cam unit.

9. The cooking appliance, according to claim 6, wherein said locking cam assembly further comprises:
a plurality of springs, each spring fitted within an aperture formed within each of said plurality of cam components; and
a plurality of rods insertable within the cam unit adjacent to and perpendicular to each of said plurality of springs.

10. The cooking appliance, according to claim 1, wherein said lower cooking plate comprises a recess for holding a whole chicken which has been opened out after being cut from the breast side.

11. The cooking appliance, according to claim 1, wherein said upper cooking plate comprises a recess for holding a whole chicken which has been opened out after being cut from the breast side.

12. A method for grilling and cooking whole chickens, comprising the steps of:
cutting the chicken open from the breast side; and
placing the cut chicken in a recessed plate, said recess being configured to accept the curvature of the cut chicken,
wherein said recessed plate is either one of the upper or lower cooking plates of a cooking appliance, said cooking appliance, comprising:
a base unit supporting a lower cooking plate;
a top unit containing an upper cooking plate; and
a pair of side levers pivotally connecting the upper cooking plate to the lower cooking plate,
wherein the angle of the upper cooking plate is variable relative to the lower cooking plate.
